(19) United States
(12) Patent Application Publication
(10) Pub. No.: US 2022/0016793 A1
(43) Pub. Date: Jan. 20, 2022

(54) BUCKLE STRUCTURE FOR SHAVER HEAD

(71) Applicant: ZHEJlANG SHALOM ELECTRIC CO., LTD, Lishui, Zhejiang (CN)

(72) Inventors: Xiangqi WANG, Lishui, Zhejiang (CN); Qiangmin WANG, Lishui, Zhejiang (CN)

(21) Appl. No.: 17/295,882

(22) PCT Filed: Nov. 23, 2018
(86) PCT No.: PCT/CN2018/117065

§ 371 Date: May 21, 2021

(51) Int. Cl. B26B 19/38; B26B 19/14

(52) U.S. Cl. CPC B26B 19/386; B26B 19/14

(57) ABSTRACT

A buckle structure for shaver head, the feature is that the connector base is formed with a mounting slot, the sidewall of the mounting slot is at least formed with two corresponding grooves; the connector is formed with an annular mounting boss, the annular mounting boss is adapted to the mounting slot, and inserted in the mounting slot, the sidewall of the annular mounting boss is formed with a mounting hole corresponding to the groove, the mounting hole is provided with a ball, and the connector is provided with an elastic piece which drives the ball to be partially exposed out of the mounting hole to clamp the groove. The advantage is that based on the buckle structure of elastic piece and ball, during assembly and disassembly, the ball rolls, the wear is reduced, the service life is long, and the assembly and disassembly are easier.

### BACKGROUND OF INVENTION

### 1. Field of the Invention

The present invention relates generally to a shaver, and more particularly a buckle structure for shaver head.

### 2. Description of Related Art

The existing shavers include electric shaver and manual shaver, the removable connection between the handle and cutter head of electric shaver is generally implemented by the buckle connection between the connecting pinch plate and pinch plate base.

However, in the buckling mode, the elasticity of the connecting pinch plate decreases after a long time, so that the buckling with the pinch plate base cannot remain, the service life is short, and the assembly and disassembly are difficult.

### SUMMARY OF THE INVENTION

In order to solve the above-mentioned problems, the technical means of the present invention are realized by the following methods:

A buckle structure for shaver head, including a connector base, a connector; the connector base and connector are installed on the upper part of shaver handle and the lower part of shaver head respectively; wherein the connector base is formed with a mounting slot, the sidewall of the mounting slot is at least formed with two corresponding grooves; the connector is formed with an annular mounting boss, the annular mounting boss is adapted to the mounting slot, and inserted in the mounting slot, the sidewall of the annular mounting boss is formed with a mounting hole corresponding to the groove, the mounting hole is provided with a ball, and the connector is provided with an elastic piece which drives the ball to be partially exposed out of the mounting hole to clamp the groove.

More particularly, wherein the mounting hole includes a mounting part in diameter adapted to the ball and a limiting part in diameter smaller than the ball outside the mounting part; the elastic piece is installed on the connector, elastically extruding the ball, so that the ball abuts on the limiting part.

More particularly, wherein the inner wall of the limiting part is a spherical structure adapted to the ball.

More particularly, wherein the elastic piece is a snap ring structure, the elastic piece is embedded in the annular mounting boss, abutting on the inner wall of annular mounting boss.

More particularly, wherein the inner wall of the annular mounting boss is at least formed with two symmetrically arranged first limiting bosses and two symmetrically arranged second limiting bosses, the first limiting bosses and the second limiting bosses are located in the upper and lower parts opposite the mounting hole respectively, the elastic piece is arranged between the first limiting bosses and the second limiting bosses.

More particularly, wherein the upper end face of the first limiting boss is a bevel guide structure.

More particularly, wherein the groove is a vertically arranged elongated structure.

More particularly, wherein the ball is a steel ball.

When the scheme is used, with the buckle structure of elastic piece and ball, the ball rolls during assembly and disassembly, the friction is reduced, less wear, long service life, and the assembly and disassembly are easier.

### BRIEF DESCRIPTION OF THE DRAWINGS

FIG. 1 is a partially exploded view of the shaver in the embodiment of the present invention;

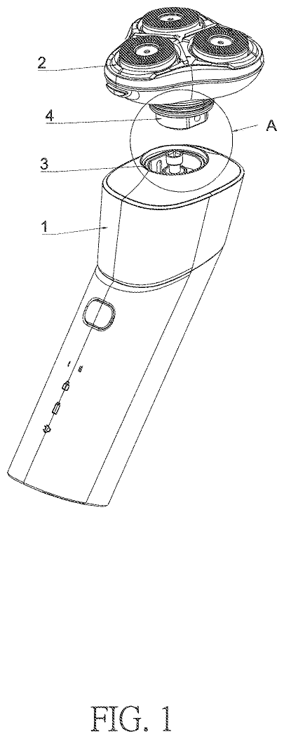

FIG. 2 is an enlarged view of Part A in FIG. 1;

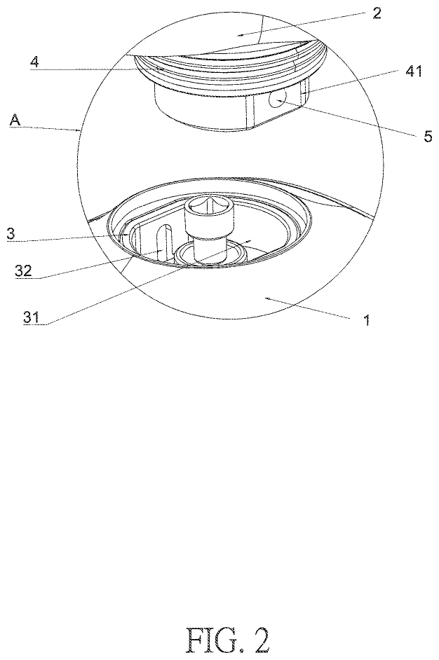

FIG. 3 is a structural representation of the connector base in the embodiment of the present invention;

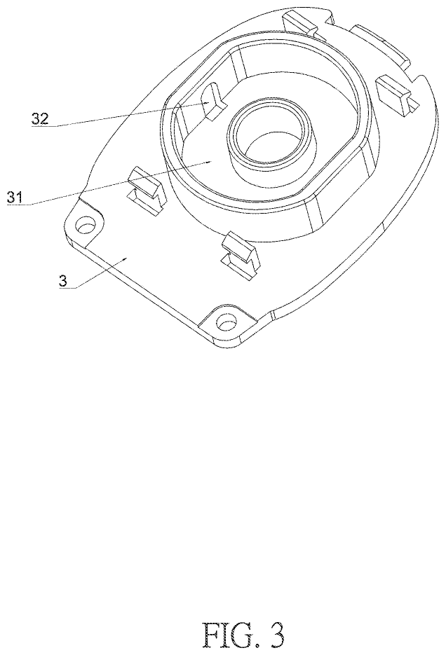

FIG. 4 is a structural representation of the connector in the embodiment of the present invention;

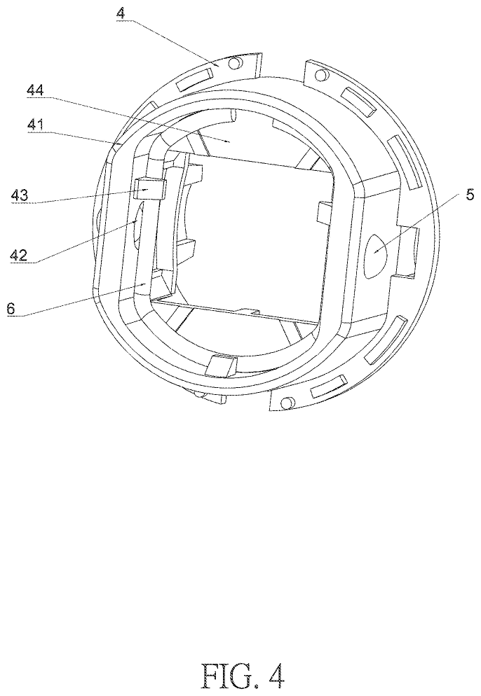

FIG. 5 is a sectional view of the connector in the embodiment of the present invention.

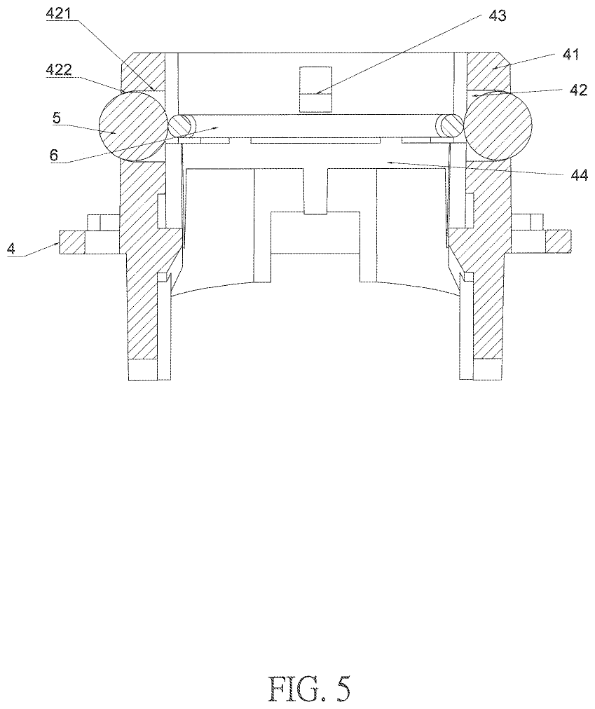

### DETAILED DESCRIPTION OF THE INVENTION

The embodiment is further described below with attached figures: As shown in Fig., a buckle structure for shaver head, including a connector base 3, a connector 4, a ball 5 and an elastic piece 6.

The connector base 3 is fixed to the upper part of shaver handle 1, the connector 4 is fixed to the lower part of shaver head 2, the connector base 3 and connector 4 are removably connected, so as to implement removable connection between shaver handle 1 and shaver head 2.

A mounting slot 31 is formed in the connector base 3, two corresponding grooves 32 are formed on the two side walls of the mounting slot 31.

The connector 4 is formed with an annular mounting boss 41, the annular mounting boss 41 is adapted to the mounting slot 31, and inserted in the mounting slot 31, the sidewall of the annular mounting boss 41 is formed with a mounting hole 42 corresponding to the groove 32, the ball 5 is installed in the mounting hole 42, the elastic piece 6 is installed on the connector 4, driving the ball 5 to be partially exposed out of the mounting hole 42, clamping the groove 32.

During assembly, the annular mounting boss 41 of connector 4 is inserted in the mounting slot 31, the ball 5 is stressed to overcome the elastic force of elastic piece 6 and retract into the mounting hole 42. When the designated position is reached, the mounting hole 42 corresponds to the groove 32, the ball 5 is ejected under the elastic force of elastic piece 6, stuck in the groove 32, the buckle connection between connector 4 and connector base 3 is implemented.

Based on the buckle structure of elastic piece 6 and ball 5, during assembly and disassembly, the ball 5 rolls, the wear is reduced, the service life is long, and the assembly and disassembly are easier.

As shown in Fig., the mounting hole 42 includes a mounting part 421 and a limiting part 422 outside the mounting part 421, the diameter of the mounting part 421 is equal to or a little larger than the diameter of ball 5, matching the ball 5, so that the ball can move axially along the mounting hole 42, the diameter of the limiting part 422 is a little smaller than the diameter of ball 5.

The elastic piece 6 is made by bending a steel wire to form an unclosed ring structure, and embedded in the annular mounting boss 41, abutting on the inner wall of annular mounting boss 41, the elastic piece 6 can extrude the ball 5, so that the ball 5 abuts on the limiting part 422, the ball 5 coordinates with the limiting part 422, and its local structure can extend out of the limiting part 422, buckling the groove 32.

The assembly and disassembly of ball 6 and elastic piece 5 are convenient, even if they are damaged after a long-term operation, they can be changed conveniently.

For better coordination of ball 5, the inner wall of the limiting part 422 can be a spherical structure adapted to the ball 5.

In addition, the inner wall of the annular mounting boss 41 is formed with multiple first limiting bosses 43 and two symmetrically arranged second limiting bosses 44, the first limiting bosses 43 and the second limiting bosses 44 are located in the upper and lower parts opposite the mounting hole 42 respectively, the elastic piece 6 is arranged between the first limiting bosses 43 and the second limiting bosses 44, the elastic piece 6 is fixed by the first limiting bosses 43 and the second limiting bosses 44, the structure is more stabilized.

For convenient installation of elastic piece, the upper end face of the first limiting boss 43 is a bevel guide structure, the bevel guide can implement rapid installation of elastic piece 6.

In addition, the groove 32 is a vertically arranged elongated structure, so that there is adequate space for the ball 5, not only convenient for installation, but also implementing floating up and down, the comfort of shaver is enhanced.

The ball 5 can be a steel ball, characterized by stable structure and unlikely wear, and it can be made of other materials.

We claim:

1. A buckle structure for shaver head, including
a connector base (3), a connector (4); the connector base (3) and connector (4) are installed on the upper part of shaver handle (1) and the lower part of shaver head (2) respectively;
wherein the connector base (3) is formed with a mounting slot (31), the sidewall of the mounting slot (31) is at least formed with two corresponding grooves (32);
the connector (4) is formed with an annular mounting boss (41), the annular mounting boss (41) is adapted to the mounting slot (31), and inserted in the mounting slot (31), the sidewall of the annular mounting boss (41) is formed with a mounting hole (42) corresponding to the groove (32), the mounting hole (42) is provided with a ball (5), and the connector (4) is provided with an elastic piece (6) which drives the ball (5) to be partially exposed out of the mounting hole (42) to clamp the groove (32).

2. The buckle structure for shaver head defined in claim 1, wherein the mounting hole (42) includes a mounting part (421) in diameter adapted to the ball (5) and a limiting part (422) in diameter smaller than the ball (5) outside the mounting part (421); the elastic piece (6) is installed on the connector (4), elastically extruding the ball (5), so that the ball (5) abuts on the limiting part (422).

3. The buckle structure for shaver head defined in claim 2, wherein the inner wall of the limiting part (422) is a spherical structure adapted to the ball (5).

4. The buckle structure for shaver head defined in claim 2, wherein the elastic piece (6) is a snap ring structure, the elastic piece (6) is embedded in the annular mounting boss (41), abutting on the inner wall of annular mounting boss (41).

5. The buckle structure for shaver head defined in claim 4, wherein the inner wall of the annular mounting boss (41) is at least formed with two symmetrically arranged first limiting bosses (43) and two symmetrically arranged second limiting bosses (44), the first limiting bosses (43) and the second limiting bosses (44) are located in the upper and lower parts opposite the mounting hole (42) respectively, the elastic piece (6) is arranged between the first limiting bosses (43) and the second limiting bosses (44).

6. The buckle structure for shaver head defined in claim 5, wherein the upper end face of the first limiting boss (43) is a bevel guide structure.

7. The buckle structure for shaver head defined in claim 1, wherein the groove (32) is a vertically arranged elongated structure.

8. The buckle structure for shaver head defined in claim 1, wherein the ball (5) is a steel ball.
